(19) United States
(12) Patent Application Publication
(10) Pub. No.: US 2022/0131590 A1
(43) Pub. Date: Apr. 28, 2022

(54) FEEDBACK OVERHEAD REDUCTION

(71) Applicant: QUALCOMM Incorporated, San Diego, CA (US)

(72) Inventors: Ruifeng MA, Beijing (CN); Yuwei REN, Beijing (CN); Bo CHEN, Beijing (CN); Renqiu WANG, San Diego, CA (US); Pavan Kumar VITTHALADEVUNI, San Diego, CA (US); Tingfang JI, San Diego, CA (US); Hao XU, Beijing (CN)

(21) Appl. No.: 17/423,410

(22) PCT Filed: Jan. 21, 2020
(86) PCT No.: PCT/CN2020/073514

§ 371 Date: Jul. 15, 2021

(30) Foreign Application Priority Data
Jan. 21, 2019 (CN) PCT/CN2019/072474

(51) Int. Cl. H04B 7/06

(52) U.S. Cl. CPC H04B 7/0658; H04B 7/0641; H04B 7/0626

(57) ABSTRACT

Certain aspects of the present disclosure generally relate to methods and apparatus for providing channel state feedback. One example method generally includes receiving at least one first pilot signal, and generating a first channel state information (CSI) report based on the at least one first pilot signal. The first CSI report may include a differential phase feedback for each subband (SB) of one or more SBs associated with the at least one first pilot signal. The method may also include transmitting the first CSI report having the differential phase feedback.

### CROSS-REFERENCE TO RELATED APPLICATIONS

This application claims priority to PCT Application No. PCT/CN2019/072474, filed Jan. 21, 2019, which is assigned to the assignee hereof and hereby expressly incorporated by reference herein in its entirety as if fully set forth below and for all applicable purposes.

### BACKGROUND

### Field of the Disclosure

Aspects of the present disclosure relate to wireless communication, and more particularly, to communication of techniques for channel information feedback.

### Description of Related Art

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include Long Term Evolution (LTE) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

In some examples, a wireless multiple-access communication system may include a number of base stations, each simultaneously supporting communication for multiple communication devices, otherwise known as user equipment (UEs). In LTE or LTE-A network, a set of one or more base stations may define an e NodeB (eNB). In other examples (e.g., in a next generation or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., a new radio base station (NR BS), a new radio node-B (NR NB), a network node, 5G NB, gNB, etc.). A base station or DU may communicate with a set of UEs on downlink channels (e.g., for transmissions from a base station or to a UE) and uplink channels (e.g., for transmissions from a UE to a BS or DU).

These multiple access technologies have been adopted in various telecommunication standards to provide a common protocol that enables different wireless devices to communicate on a municipal, national, regional, and even global level. An example of an emerging telecommunication standard is new radio (NR), for example, 5G radio access. NR is a set of enhancements to the LTE mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL) as well as support beamforming, multiple-input multiple-output (MEMO) antenna technology, and carrier aggregation.

However, as the demand for mobile broadband access continues to increase, there exists a need for further improvements in NR technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure generally relate to methods and apparatus for providing channel state feedback.

Certain aspects are directed to a method for wireless communication. The method generally includes receiving at least one first pilot signal, and generating a first channel state information (CSI) report based on the at least one first pilot signal. The first CSI report may include a differential phase feedback for each subband (SB) of one or more SBs associated with the at least one first pilot signal. The method may also include transmitting the first CSI report having the differential phase feedback.

Certain aspects are directed to a method for wireless communication. The method generally includes transmitting at least one first pilot signal, receiving a first CSI report from a user-equipment (UE) after the transmission of the at least one first pilot signal, the first CSI report comprising a differential phase feedback for each SB of one or more SBs associated with the at least one first pilot signal, generating one or more data packets for transmission in accordance with the first CSI report, and transmitting the one or more data packets to the UE.

Certain aspects are directed to an apparatus for wireless communication. The apparatus generally includes a receiver configured to receive at least one first pilot signal, a processing system configured to generate a first CSI report based on the at least one first pilot signal, the first CSI report comprising a differential phase feedback for each SB of one or more SBs associated with the at least one first pilot signal, and a transmitter configured to transmit the first CSI report having the differential phase feedback.

Certain aspects are directed to an apparatus for wireless communication. The apparatus generally includes a transmitter configured to transmit at least one first pilot signal, a receiver configured to receive a first CSI report from a UE after the transmission of the at least one first pilot signal, the first CSI report comprising a differential phase feedback for each SB of one or more SBs associated with the at least one first pilot signal, and a processing system configured to generate one or more data packets for transmission in accordance with the first CSI report, wherein the transmitter is further configured to transmit the one or more data packets to the UE.

Certain aspects are directed to an apparatus for wireless communication. The apparatus generally includes means for receiving at least one first pilot signal, means for generating a first CSI report based on the at least one first pilot signal, the first CSI report comprising a differential phase feedback for each SB of one or more SBs associated with the at least one first pilot signal, and means for transmitting the first CSI report having the differential phase feedback.

Certain aspects are directed to an apparatus for wireless communication. The apparatus generally includes means for transmitting at least one first pilot signal, means for receiving a first CSI report from a UE after the transmission of the at least one first pilot signal, the first CSI report comprising a differential phase feedback for each SB of one or more SBs associated with the at least one first pilot signal, means for generating one or more data packets for transmission in accordance with the first CSI report; and means for transmitting the one or more data packets to the UE.

Certain aspects are directed to a computer-readable medium having instructions stored thereon to cause a processor to receive at least one first pilot signal, generate a first CSI report based on the at least one first pilot signal, the first CSI report comprising a differential phase feedback for each SB of one or more SBs associated with the at least one first pilot signal, and transmit the first CSI report having the differential phase feedback.

Certain aspects are directed to a computer-readable medium having instructions stored thereon to cause a processor to transmit at least one first pilot signal, receive a first CSI report from a UE after the transmission of the at least one first pilot signal, the first CSI report comprising a differential phase feedback for each SB of one or more SBs associated with the at least one first pilot signal, generate one or more data packets for transmission in accordance with the first CSI report, and transmit the one or more data packets to the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIG. 5 is a diagram showing examples for implementing a communication protocol stack, in accordance with certain aspects of the present disclosure.

FIG. 6 illustrates an example of a frame format for a new radio (NR) system, in accordance with certain aspects of the present disclosure.

FIG. 7A illustrates example channel state feedback operations.

FIG. 7B is a table illustrating total payload for CSI feedback corresponding to different configuration settings.

FIG. 8 is a flow diagram illustrating example operations for wireless communication by a UE, in accordance with certain aspects of the present disclosure.

FIG. 9 is a flow diagram illustrating example operations for wireless communication by a BS, in accordance with certain aspects of the present disclosure.

FIG. 10 illustrates example step-size indications, in accordance with certain aspects of the present disclosure.

FIG. 11 illustrates absolute and differential phase feedback across multiple slots and subbands, in accordance with certain aspects of the present disclosure.

FIG. 12 illustrates absolute and differential phase feedback with network configured periodicity for absolute feedback, in accordance with certain aspects of the present disclosure.

FIG. 13 illustrates a communications device that may include various components configured to perform operations for the techniques disclosed herein in accordance with aspects of the present disclosure.

FIG. 14 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for reducing overhead associated with providing channel state feedback. For example, channel state information (CSI) report may include differential phase feedback, indicating a phase offset with respect to a previously indicated absolute phase feedback, as described in more detail herein.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication networks such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). NR is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G, 4G, 5G, or NR wireless technologies, aspects of the present disclosure can be applied in other generation-based communication systems.

### Example Wireless Communications System

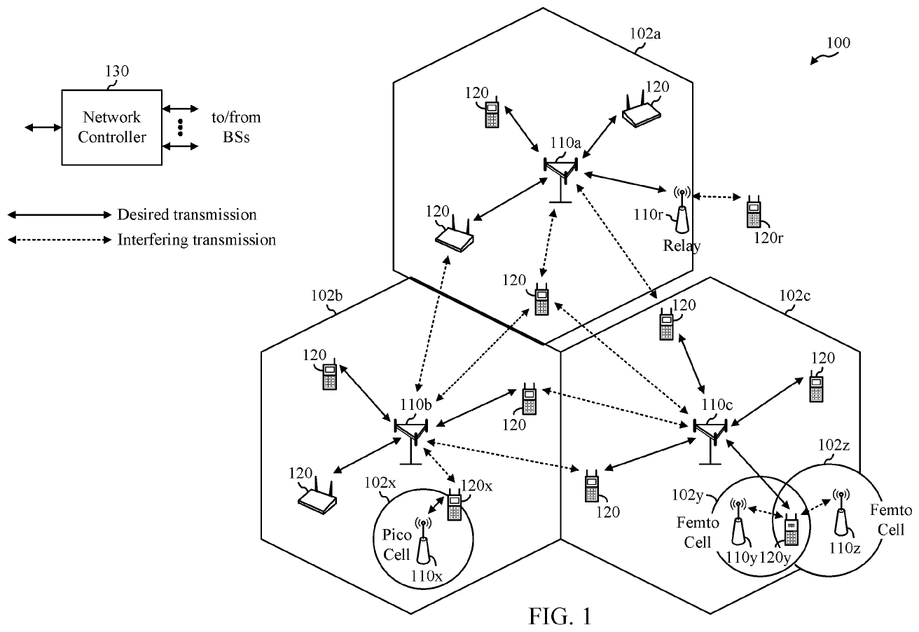

FIG. 1 illustrates an example wireless communication network 100 in which aspects of the present disclosure may be performed. For example, the wireless communication network 100 may be a New Radio (NR) or 5G network.

As illustrated in FIG. 1, the wireless communication network 100 may include a number of base stations (BSs) 110 and other network entities. A BS may be a station that communicates with user equipments (UEs). Each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and next generation NodeB (gNB or gNodeB), NR BS, 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.8 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MEMO transmissions with precoding may also be supported. MEMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

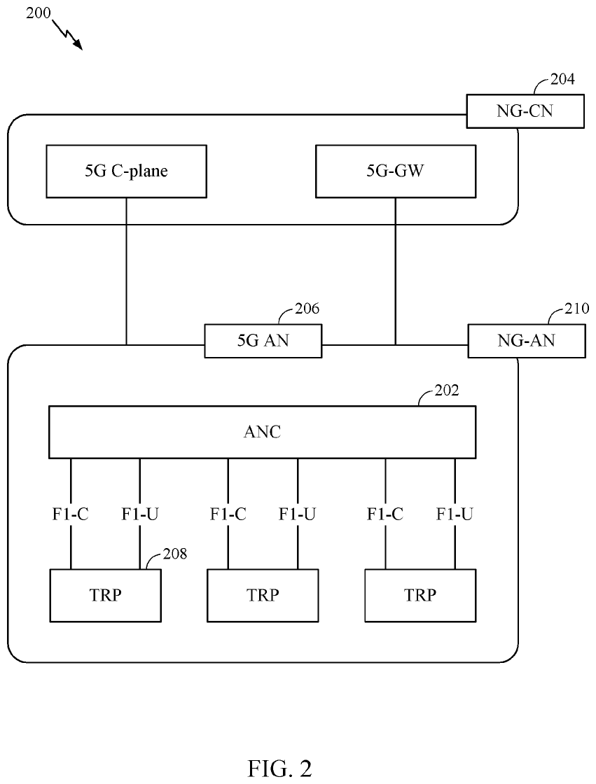

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

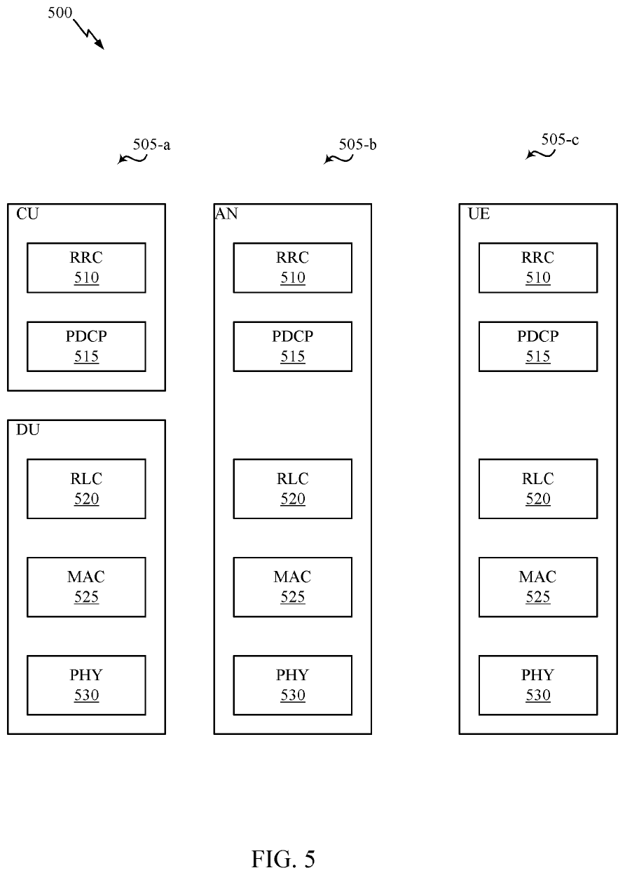

Logical functions may be dynamically distributed in the logical architecture of distributed RAN 200. As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

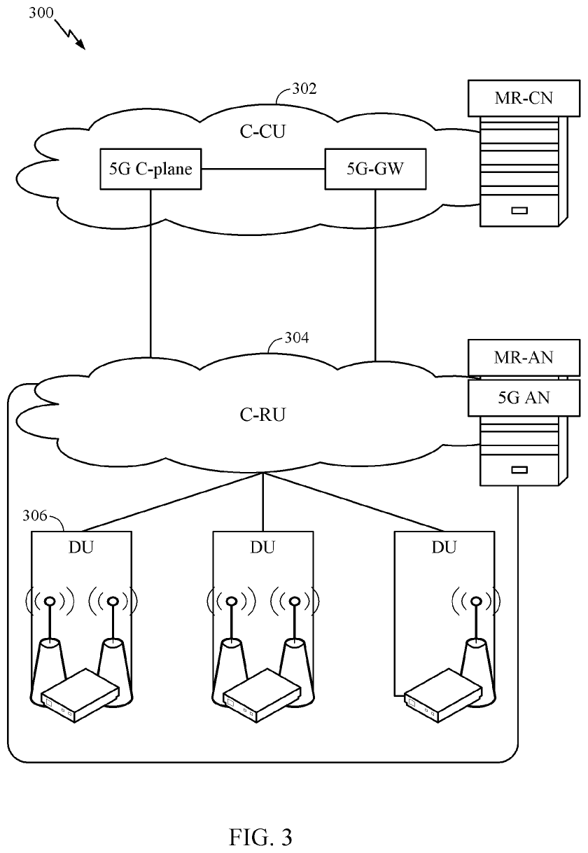

FIG. 3 illustrates an example physical architecture of a distributed RAN 300, according to aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

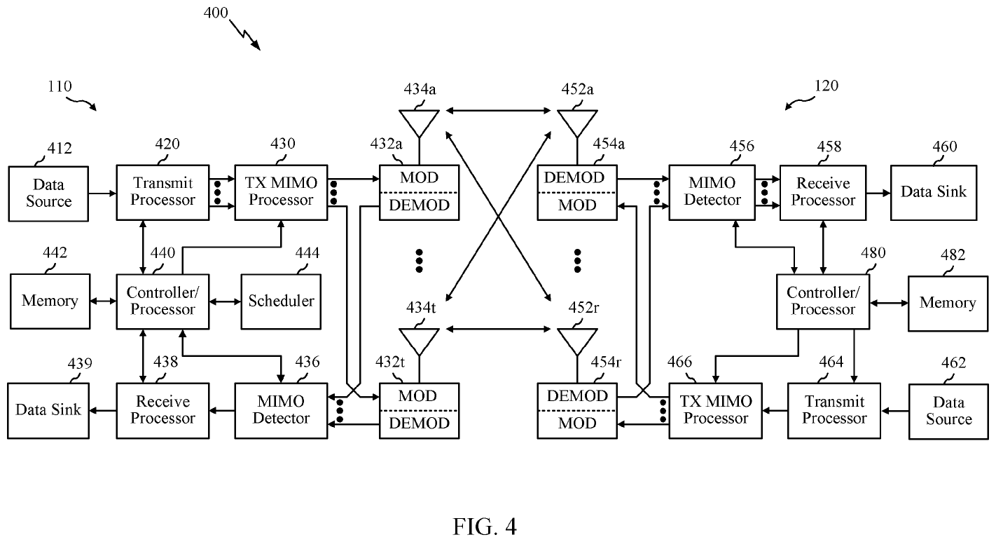

FIG. 4 illustrates example components of BS 110 and UE 120 (as depicted in FIG. 1), which may be used to implement aspects of the present disclosure. For example, antennas 452, processors 466, 458, 464, and/or controller/processor 480 of the UE 120 and/or antennas 434, processors 420, 430, 438, and/or controller/processor 440 of the BS 110 may be used to perform the various techniques and methods described herein.

At the BS 110, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at UE 120, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the base station 110. At the BS 110, the uplink signals from the UE 120 may be received by the antennas 434, processed by the modulators 432, detected by a MEMO detector 436 if applicable, and further processed by a receive processor 438 to obtain decoded data and control information sent by the UE 120. The receive processor 438 may provide the decoded data to a data sink 439 and the decoded control information to the controller/processor 440.

The controllers/processors 440 and 480 may direct the operation at the BS 110 and the UE 120, respectively. The processor 440 and/or other processors and modules at the BS 110 may perform or direct the execution of processes for the techniques described herein. The memories 442 and 482 may store data and program codes for BS 110 and UE 120, respectively. A scheduler 444 may schedule UEs for data transmission on the downlink and/or uplink.

FIG. 5 illustrates a diagram 500 showing examples for implementing a communications protocol stack, according to aspects of the present disclosure. The illustrated communications protocol stacks may be implemented by devices operating in a wireless communication system, such as a 5G system (e.g., a system that supports uplink-based mobility). Diagram 500 illustrates a communications protocol stack including a RRC layer 510, a PDCP layer 515, a RLC layer 520, a MAC layer 525, and a PHY layer 530. In various examples, the layers of a protocol stack may be implemented as separate modules of software, portions of a processor or ASIC, portions of non-collocated devices connected by a communications link, or various combinations thereof. Collocated and non-collocated implementations may be used, for example, in a protocol stack for a network access device (e.g., ANs, CUs, and/or DUs) or a UE.

A first option 505-a shows a split implementation of a protocol stack, in which implementation of the protocol stack is split between a centralized network access device (e.g., an ANC 202 in FIG. 2) and distributed network access device (e.g., DU 208 in FIG. 2). In the first option 505-a, an RRC layer 510 and a PDCP layer 515 may be implemented by the central unit, and an RLC layer 520, a MAC layer 525, and a PHY layer 530 may be implemented by the DU. In various examples the CU and the DU may be collocated or non-collocated. The first option 505-a may be useful in a macro cell, micro cell, or pico cell deployment.

A second option 505-b shows a unified implementation of a protocol stack, in which the protocol stack is implemented in a single network access device. In the second option, RRC layer 510, PDCP layer 515, RLC layer 520, MAC layer 525, and PHY layer 530 may each be implemented by the AN. The second option 505-b may be useful in, for example, a femto cell deployment.

Regardless of whether a network access device implements part or all of a protocol stack, a UE may implement an entire protocol stack as shown in 505-c (e.g., the RRC layer 510, the PDCP layer 515, the RLC layer 520, the MAC layer 525, and the PHY layer 530).

In LTE, the basic transmission time interval (TTI) or packet duration is the 1 ms subframe. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing.

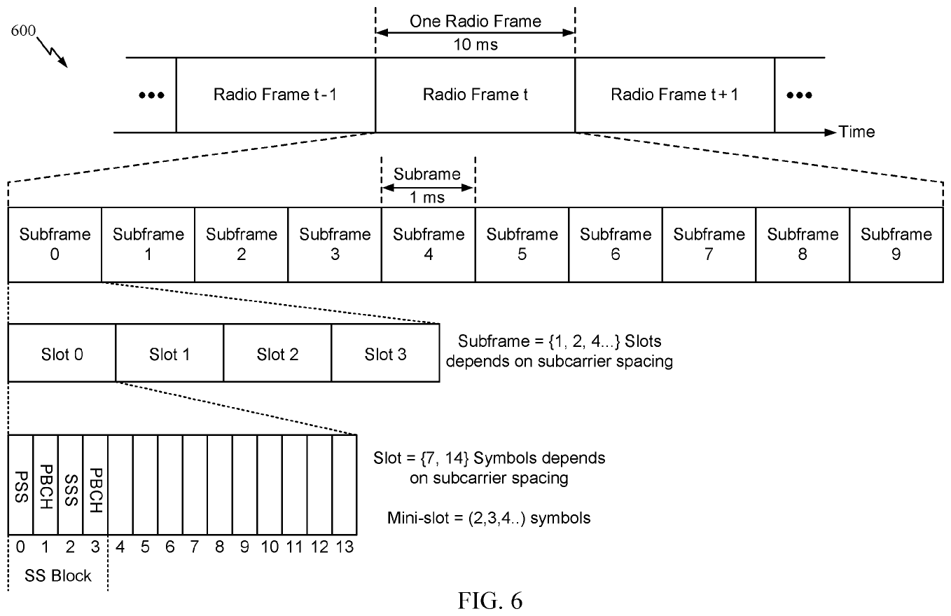

FIG. 6 is a diagram showing an example of a frame format 600 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 6. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SS block can be transmitted up to sixty-four times, for example, with up to sixty-four different beam directions for mmW. The up to sixty-four transmissions of the SS block are referred to as the SS burst set. SS blocks in an SS burst set are transmitted in the same frequency region, while SS blocks in different SS bursts sets can be transmitted at different frequency locations.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example Techniques for Reducing Channel State Information Feedback Overhead

Channel state information (CSI) may refer to known channel properties of a communication link. The CSI may represent the combined effects of, for example, scattering, fading, and power decay with distance between a transmitter and receiver. Channel state operations using pilot signals, such as CSI reference signals (CSI-RS), may be performed to determine these effects on the channel. CSI may be used to adapt transmissions based on the current channel conditions, which is useful for achieving reliable communication, in particular, with high data rates in multi-antenna systems. CSI is typically estimated at the receiver, quantized, and fed back to the transmitter.

A network (e.g., base station 110), may configure UEs for CSI reporting. For example, the BS 110 may configure the UE 120 with a CSI report configuration (sometimes referred to as a ‘CSI report setting’) or with multiple CSI report configurations. The CSI report configuration may be provided to the UE 120 via higher layer signaling, such as radio resource control (RRC) signaling. The CSI report configurations may be associated with CSI-RS resources used for channel measurement (CM), interference measurement (IM), or both. The CSI report configuration configures CSI-RS resources (sometimes referred to as the ‘CSI-RS resource setting’) for measurement. The CSI-RS resources provide the UE with the configuration of CSI-RS ports, or CSI-RS port groups, mapped to time and frequency resources (e.g., resource elements (REs)).

The CSI report configuration may also configure the CSI parameters to be reported using codebooks. Three example types of codebooks include Type I single panel, Type I multi-panel, and Type II single panel. Regardless of which codebook is used, the CSI report may include a channel quality indicator (CQI), a precoding matrix indicator (PMI), a CSI-RS resource indicator (CRI), and/or a rank indicator (RI). The structure of the PMI may vary based on the codebook.

The PMI may include a W1 matrix (e.g., subset of beams) and a W2 matrix (e.g., phase for cross polarization combination and beam selection). In some cases, the PMI may also include a phase for cross panel combination. For the Type II single panel codebook, the PMI is a linear combination of beams and has a subset of orthogonal beams to be used for linear combination and has per layer, per polarization, amplitude and phase for each beam. For the PMI of any type, there may be wideband (WB) PMI and/or subband (SB) PMI as configured.

The CSI report configuration may configure the UE for aperiodic, periodic, or semi-persistent CSI reporting. For periodic CSI, the UE may be configured with periodic CSI-RS resources. Periodic CSI and semi-persistent CSI report on physical uplink control channel (PUCCH) may be triggered via radio resource control (RRC) or a medium access control (MAC) control element (CE). For aperiodic and semi-persistent CSI on the physical uplink shared channel (PUSCH), the BS 110 may signal the UE 120 a CSI report trigger indicating for the UE to send a CSI report for one or more CSI-RS resources, or configure the CSI-RS report trigger state. The CSI report trigger for aperiodic CSI and semi-persistent CSI on PUSCH may be provided via downlink control information (DCI). The CSI-RS trigger may be signaling indicating to the UE that CSI-RS will be transmitted for the CSI-RS resource.

The UE may report the CSI feedback based on the CSI report configuration and the CSI report trigger. For example, the UE may measure the channel associated with CSI for the triggered CSI-RS resources. Based on the measurements, the UE may select one or more preferred CSI-RS resources or select a CSI-RS resource comprising one or more port groups. The UE may report the CSI feedback for each of the CSI-RS resources and/or port groups.

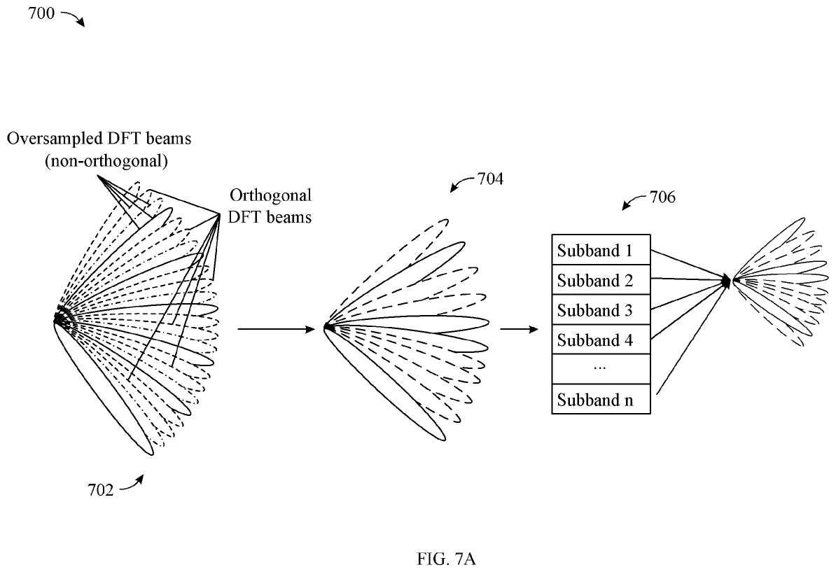

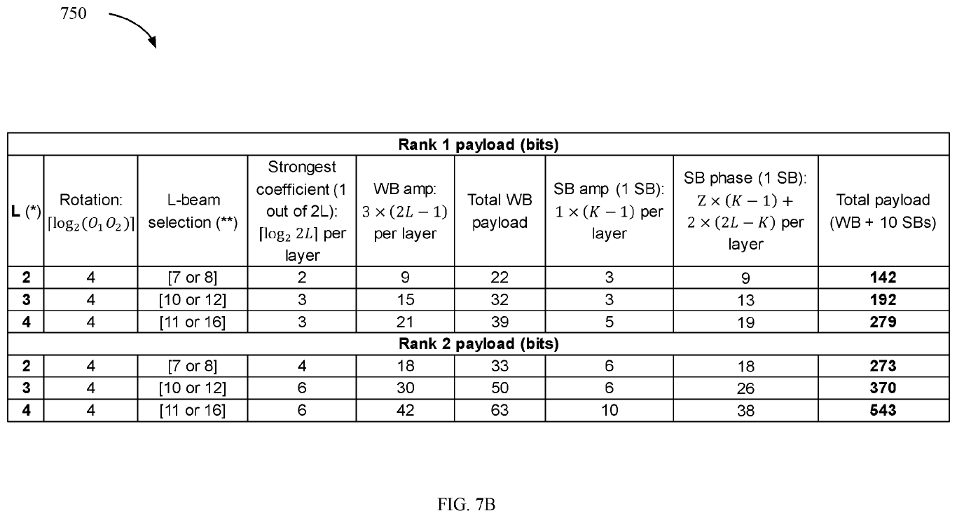

FIG. 7A illustrates example channel state feedback operations 700. As illustrated, oversampled Discrete Fourier Transform (DFT) beams 702 may be transmitted by BS 110. The UE 120 may generate a W1 matrix (e.g., select W1 beams 704) for feedback to the BS 110 based on the DFT beams 702. The W1 beams may be wideband only, and the number of W1 beams may be less than or equal to four. The UE 120 may also generate a W2 matrix (e.g., W2 linear combination) for subbands 706 based on the selected beams in the W1 matrix. In certain aspects, amplitude scaling may be wideband or subband based on previous configuration settings. In some cases, phase for combining coefficients may be subband only.

As described herein, PMI is used for spatial channel information feedback. The PMI codebook assumes the following precoder structure depending on rank:

For rank 1:

$$W = [ \begin{matrix}{\tilde{W}}_{0 , 0} \\ {\tilde{W}}_{1 , 0}\end{matrix} ] = {W}_{1} {W}_{2} ,$$

W being normalized to 1
For rank 2:

$$W = [ \begin{matrix}{\tilde{W}}_{0 , 0} & {\tilde{W}}_{0 , 1} \\ {\tilde{W}}_{1 , 0} & {\tilde{W}}_{1 , 1}\end{matrix} ] = {W}_{1} {W}_{2} ,$$

columns of W being normalized to

$$\frac{1}{\sqrt{2}}$$

\tilde{w}_{r,l} is a weighted combination of L beams, represented by the following equation:

$${\tilde{w}}_{r , l} = {\sum }_{i = 0}^{L - 1} {b}_{{k}_{1}^{( i )} {k}_{2}^{( i )}} \cdot {p}_{r , l , i}^{( WB )} \cdot {p}_{r , l , i}^{( SB )} \cdot {c}_{r , l , i}$$

The value of L is configurable (L∈{2,3,4}). bₖ_{₁}_{,k}_{₂} is an oversampled two dimensional (2D) DFT beam, r may be either 0 or 1 indicating polarization, and l may be either 0 or 1 indicating layer. p_{r,l,i}^{(WB)} is a WB beam amplitude scaling factor for beam i and on polarization r and layer l. p_{r,l,i}^{(SB)} is a subband beam amplitude scaling factor for beam i, on polarization r, and layer l. c_{r z j} is a beam combining coefficient (phase) for beam i, on polarization r, and layer l. In some cases, c_{r,l,i} may be configurable between quadrature phase shift keying (QPSK) (e.g., 2 bits) and eight phase shift keying (8PSK) (e.g., 3 bits). The amplitude scaling mode is also configurable between both WB and SB with unequal bit allocations or WB only.

Amplitude scaling may be performed by the UE independently for each beam, polarization, and layer. The UE may be configured to report WB amplitude with or without SB amplitude. For example, for reporting of both WB and SB amplitudes (Wideband p_{r,l,i}^{(WB)}+Subband p_{r,l,i}^{(SB)}), both p_{0,0,i}^{(WB)}≠p_{0,1,i}^{(WB)}≠p_{1,0,i}^{(WB)}≠p_{1,1,i}^{(WB)} and (p_{0,0,i}^{(SB)}≠p_{0,1,i}^{(SB)}≠p_{1,0,i}^{(SB)}≠p_{1,1,i}^{(SB)}) are possible. For WB only (Wideband p_{r,l,i}^{(WB)} only), p_{0,0,i}^{(WB)}≠p_{0,1,i}^{(WB)}≠p_{1,0,i}^{(WB)}≠p_{1,1,i}^{(WB)} is possible. A wideband amplitude value set (e.g., 3 bits) may be used to indicate one of wideband amplitudes 1, \sqrt{0.5}, \sqrt{0.25}, \sqrt{0.125}, \sqrt{0.0625}, \sqrt{0.0313}, \sqrt{0.0156}, 0. The PMI payload may vary depending on whether the amplitude is zero or not. The subband amplitude value set may be 1 bit used to select one of subband amplitudes 1, \sqrt{0.5}. The phase for combining coefficients may be selected independently for each beam, polarization, and layer, and may be for subband only. The phase value set may be either

$$\{ {e}^{j \frac{π n}{2}} , n = 0 , 1 , 2 , 3 \}$$

(e.g., n being indicated via 2 bits) or

$$\{ {e}^{j \frac{π n}{4}} , n = 0 , 1 , … , 7 \}$$

(e.g., n being indicated via 3 bits).

WB amplitude, SB amplitude, and SB phase may be quantized and reported in respective X, Y, and Z bits. For each layer, for the leading (strongest) coefficient out of 2L coefficients, (X, Y, Z)=(0,0,0). In some cases, the leading (strongest) coefficient may be set to 1. For WB+SB amplitude, (X, Y)=(3,1) and Z∈{2,3} for the first (K−1) leading (strongest) coefficients out of (2L−1) coefficients, and (X,Y,Z)=(3,0,2) for the remaining (2L−K) coefficients. For L equal to 2, 3, and 4, the corresponding value of K is equal to 4 (e.g., 2L), 4, and 6, respectively.

Certain coefficient index information may be reported in a WB manner. For example, the index of strongest coefficient out of 2L coefficients (per layer) may be reported in a WB manner. The (K−1) leading coefficients may be determined implicitly from reported (2L−1) WB amplitude coefficients per layer without additional signaling. For WB-only amplitude, (e.g., Y=0), (X, Y) may be equal to (3, 0) and Z∈{2,3}. The index of the strongest coefficient out of 2L coefficients is reported per layer in a WB manner.

FIG. 7B is a table 750 illustrating total payload for CSI feedback corresponding to different configuration settings. As illustrated, the total payload for WB and ten SBs may be significant, resulting in a large amount of overhead when indicating phase for combining coefficients in an absolute (traditional) manner. It is important to reduce the overhead for subband co-phase feedback, especially for devices with low time/frequency resources (e.g., low-tier UEs without sufficient UL report resources). Certain aspects of the present disclosure provide techniques for reducing CSI report overhead by using a differential phase feedback. Using a differential phase feedback may result in a significant reduction in overhead (total payload), as illustrated in table 750.

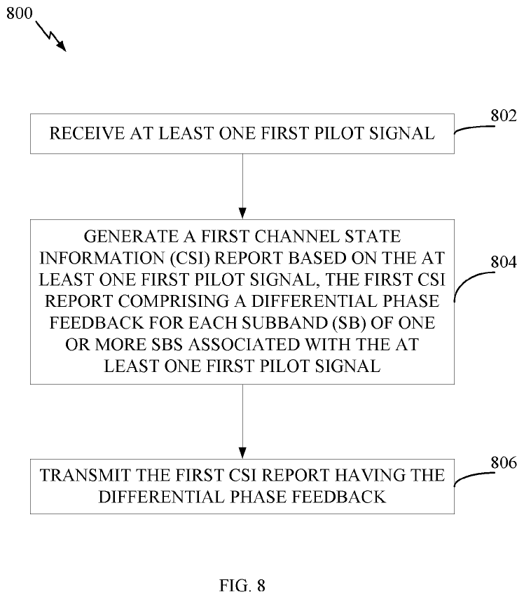

FIG. 8 is a flow diagram illustrating example operations 800 for wireless communication, in accordance with certain aspects of the present disclosure. The operations 800 may be performed by a UE, such as the UE 120.

The operations 800 begin, at block 802, with the UE receiving at least one first pilot signal, and at block 804, generating a first CSI report based on the at least one first pilot signal, the first CSI report including a differential phase feedback for each SB of one or more SBs associated with the at least one first pilot signal. At block 806, the UE transmits the first CSI report having the differential phase feedback.

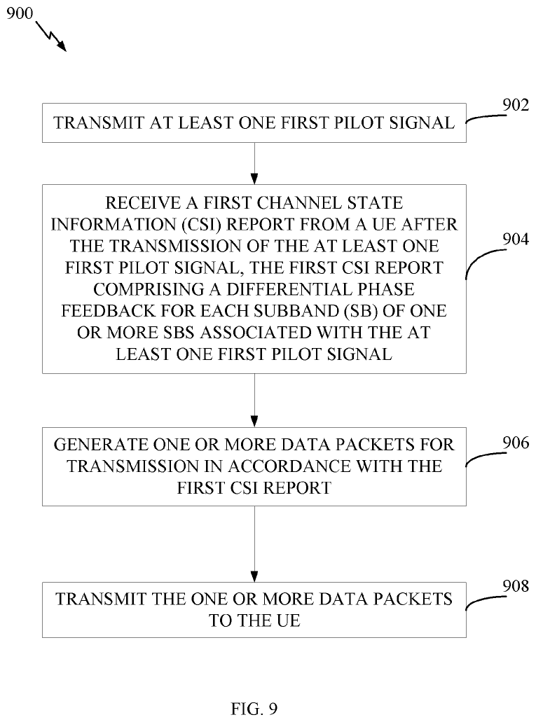

FIG. 9 is a flow diagram illustrating example operations 900 for wireless communication, in accordance with certain aspects of the present disclosure. The operations 900 may be performed by a base station, such as the base station 110.

The operations 900 begin, at block 902, by transmitting at least one first pilot signal, and at block 904, receiving a first CSI report from a UE after the transmission of the at least one first pilot signal, the first CSI report including a differential phase feedback for each SB of one or more SBs associated with the at least one first pilot signal. At block 906, the base station generates one or more data packets for transmission in accordance with the first CSI report, and at block 908, transmits the one or more data packets to the UE.

In certain aspects, the first CSI report may include two parts. For example, the first part of the CSI report may contain RI, CQI, indication of the number of non-zero wideband amplitude coefficients per layer, and indication of whether a second part of the CSI report includes an absolute type feedback or differential type feedback. In certain aspects, the presence of a bit in the first part of the CSI report may indicate whether absolute or different feedback is used.

A fixed payload size may be used for the first part of the CSI report. Each field of the first part of the CSI report may be encoded separately. The first part may also be used to identify the number of information bits of the second part of the CSI report, as well as to identify whether differential feedback is enabled, as described herein.

The second part of the CSI report may include PMI corresponding to indicated non-zero wideband amplitude coefficient per layer in the first part of the CSI report. If there is no indication that differential phase feedback enabled in the first part of CSI report, the second part includes WB and SB amplitude feedback and absolute SB co-phase feedback. Otherwise, if the indication of differential feedback is present in the first part of the CSI report, the second part includes WB and SB amplitude feedback, differential type SB co-phase feedback, as well as an indication of SB co-phase differential step size (e.g., 2 bits), as described in more detail herein. In certain aspects, the indication of SB co-phase differential step size may be included in the first part of the CSI-report.

The aspects described herein may be supported for semi-persistent/aperiodic CSI reporting and may be carried on long physical uplink control channel (PUCCH) (e.g., including only the first part of the CSI report) and/or physical uplink shared channel (PUSCH) (e.g., including both the first and second parts of the CSI report). In certain aspects, differential feedback may be supported for semi-persistent CSI reporting only.

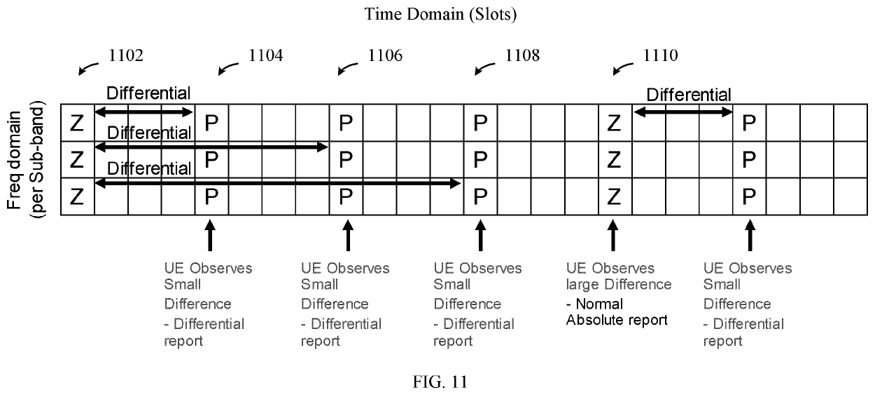

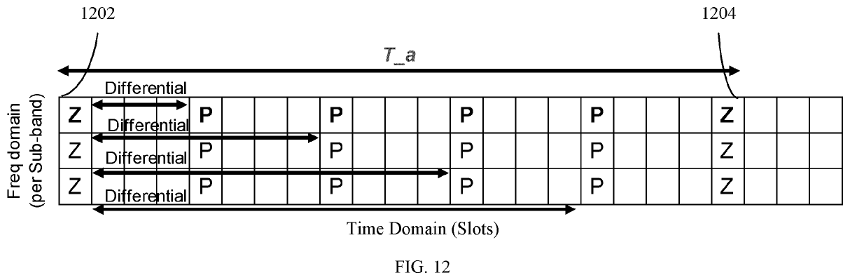

A semi-persistent CSI report may support different periodicities such as 5, 10, 20, 40, 80, 160, or 320 slots. A UE may autonomously determine whether absolute feedback or differential feedback is to be used and send an indication in the first part of the CSI report, as described in more detail with respect to FIG. 11. In certain aspects, the network may configure the periodicity for the UE to provide absolute feedback, as described in more detail with respect to FIG. 12.

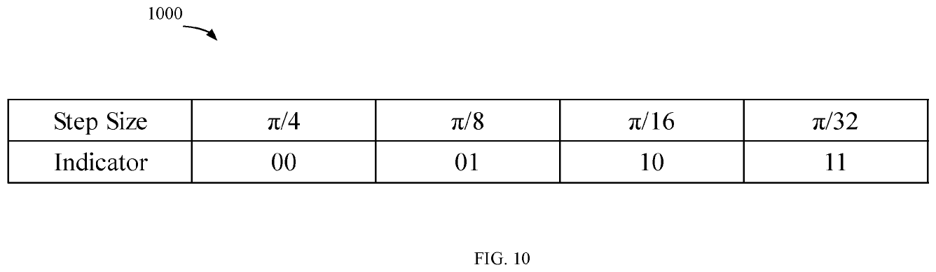

FIG. 10 is a table 1000 illustrates example step-size indications, in accordance with certain aspects of the present disclosure. The step-size for differential feedback may be reported by the UE (e.g., via 2 bits). As illustrated, the step size may be selected from π/4, π/8, π/16, and π/32. The step size for phase differential adjustment may be determined by the UE based on UE staged detection. For example, a differential co-phase reporting bit P (e.g., 1 bit) may be used with a step size of π/8. If the different phase is greater than zero, the UE may feedback P=1, indicating baseline phase plus π/8, where the baseline phase corresponds to the last absolute phase indication. Otherwise, the UE may feedback P=0, indicating the baseline phase minus π/8.

FIG. 11 illustrates absolute and differential phase feedback across multiple slots and subbands, in accordance with certain aspects of the present disclosure. The absolute phase feedback is represented in FIG. 11 by bits Z (e.g., Z may be 3 bits), and differential phase feedback is represented in FIG. 11 by bit P (e.g., P may be a single bit as described herein). As illustrated, in slot 1102, absolute phase feedback may be determined based on pilot signals and provided for each of the SBs. In slot 1104, the UE may observe a small difference in phase based on received pilot signals, with respect to the previous absolute phase feedback in slot 1102. In other words, the UE may determine that the phase difference (offset) with respect to the absolute phase feedback is below a threshold. Therefore, the UE may indicate a differential phase feedback in slot 1104. In a similar manner, the UE may indicate a differential phase feedback in slots 1106, 1108. In slot 1110, the UE may determine that the difference in phase based on received pilot signals, with respect to the previous absolute phase feedback in slot 1102, is too large (e.g., above a certain a threshold). Therefore, in slot 1110, the UE may transmit an absolute phase feedback indication.

FIG. 12 illustrates absolute and differential phase feedback with network configured periodicity for absolute feedback, in accordance with certain aspects of the present disclosure. In otherwise, the network may configure the periodicity T_a indicating the period between slots 1202, 1204 having absolute phase feedback indications. In certain aspects, the periodicity T_a may be RRC configured by the network (e.g., a network entity). As illustrated, each different phase feedback may be with respect to a previous transmitted absolute phase feedback that is in accordance with the periodicity T_a.

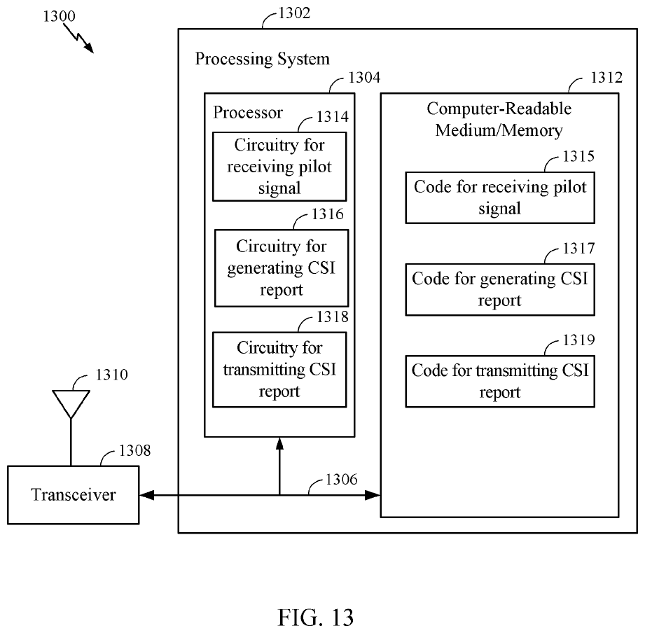

FIG. 13 illustrates a communications device 1300 that may include various components (e.g., corresponding to means-plus-function components) configured to perform operations for the techniques disclosed herein, such as the operations illustrated in FIG. 8. The communications device 1300 includes a processing system 1302 coupled to a transceiver 1308. The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer executable code) that when executed by the processor 1304, cause the processor 1304 to perform the operations illustrated in FIG. 8, or other operations for performing the various techniques discussed herein. In certain aspects, computer-readable medium/memory 1312 stores code 1315 for receiving a pilot signal, code 1317 for generating a CSI report, and code 1319 for transmitting the CSI report. In certain aspects, the processor 1304 has circuitry configured to implement the code stored in the computer-readable medium/memory 1312. The processor 1304 may include circuitry 1314 for receiving a pilot signal, circuitry 1316 for generating a CSI report, and circuitry 1318 for transmitting the CSI report.

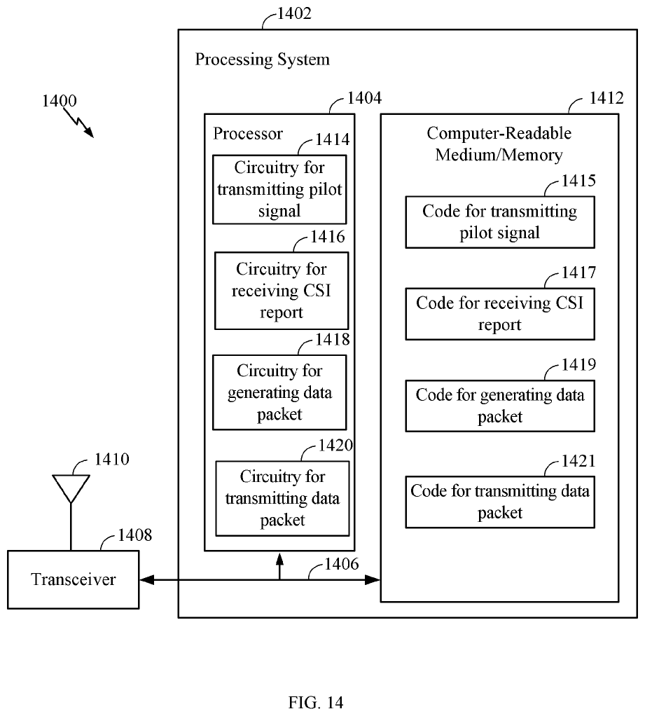

FIG. 14 illustrates a communications device 1400 that may include various components (e.g., corresponding to means-plus-function components) configured to perform operations for the techniques disclosed herein, such as the operations illustrated in FIG. 9. The communications device 1400 includes a processing system 1402 coupled to a transceiver 1408. The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes a processor 1404 coupled to a computer-readable medium/memory 1412 via a bus 1406. In certain aspects, the computer-readable medium/memory 1412 is configured to store instructions (e.g., computer executable code) that when executed by the processor 1404, cause the processor 1404 to perform the operations illustrated in FIG. 9, or other operations for performing the various techniques discussed herein. In certain aspects, computer-readable medium/memory 1412 stores code 1415 for transmitting a pilot signal, code 1417 for receiving a CSI report, code 1419 for generating a data packet, and code 1421 for transmitting the data packet. In certain aspects, the processor 1404 has circuitry configured to implement the code stored in the computer-readable medium/memory 1412. The processor 1404 may include circuitry 1414 for transmitting a pilot signal, circuitry 1416 for receiving a CSI report, circuitry 1418 for generating a data packet, and circuitry 1420 for transmitting the data packet.

### Example Aspects

In a first aspect, a method for wireless communication, includes: receiving at least one first pilot signal; generating a first channel state information (CSI) report based on the at least one first pilot signal, the first CSI report comprising a differential phase feedback for each subband (SB) of one or more SBs associated with the at least one first pilot signal; and transmitting the first CSI report having the differential phase feedback.

In a second aspect, in combination with the first aspect, the differential phase feedback indicates a phase offset with respect to a previously transmitted indication of an absolute phase feedback.

In a third aspect, in combination with one or more of the first aspect and the second aspect, the first CSI report comprises an indication of whether the first CSI report comprises the differential phase feedback or absolute phase feedback.

In a fourth aspect, in combination with the third aspect, the indication of whether the first CSI report comprises the differential phase feedback or the absolute phase feedback comprises two bits.

In a fifth aspect, in combination with one or more of the third aspect to the fourth aspect, the first CSI report comprises: a first part having at least one of a rank indicator (RI), a channel quality indicator (CQI), or an indication of a number of non-zero wideband amplitude coefficients per layer; and a second part comprising a precoding matrix indicator (PMI), wherein the first part further comprise the indication of whether the second part of the first CSI report comprises the differential phase feedback or the absolute phase feedback.

In a sixth aspect, in combination with the fifth aspect, a presence of a bit in the first part of the first CSI report indicates whether the second part of the first CSI report comprises the differential phase feedback or the absolute phase feedback.

In a seventh aspect, in combination with one or more of the fifth aspect and the sixth aspect, the first part further comprises an indication of a step size associated with the differential phase feedback.

In an eighth aspect, in combination with one or more of the first aspect to the seventh aspect, the first CSI report comprises an indication of a step size associated with the differential phase feedback.

In a ninth aspect, in combination with one or more of the first aspect to the eighth aspect, the method further comprises detecting an amount of phase offset with respect to a previously transmitted indication of an absolute phase feedback based on the at least one first pilot signal; and determining whether to provide the differential phase feedback or an absolute phase feedback based on whether the amount of phase offset is greater than a threshold, wherein the first CSI report comprises the differential phase feedback based on the determination.

In a tenth aspect, in combination with one or more of the first aspect to the ninth aspect, the method further comprises: receiving at least one second pilot signal; generating a second CSI report based on the at least one second pilot signal, the second CSI report comprising an absolute phase feedback for the SB, wherein the differential phase feedback of the first CSI report indicates a phase offset with respect to the absolute phase feedback of the second CSI report; and transmitting the second CSI report, the second CSI report being transmitted prior to the transmission of the first CSI report.

In an eleventh aspect, in combination with the tenth aspect, the method further comprises: receiving at least one third pilot signal; generating a third CSI report based on the at least one third pilot signal, the third CSI report comprising another absolute phase feedback for the SB; and transmitting the third CSI report, the third CSI report being transmitted after the transmission of the first CSI report.

In a twelfth aspect, in combination with the eleventh aspect, the second CSI report is transmitted during a first slot, the third CSI report is transmitted during a second slot, and a period between the first and second slots is configured by a network entity.

In a thirteenth aspect, in combination with one or more of the first aspect to the twelfth aspect, the differential phase feedback comprises a single bit.

In a fourteenth aspect, a method for wireless communication, includes: transmitting at least one first pilot signal; receiving a first CSI report from a UE after the transmission of the at least one first pilot signal, the first CSI report comprising a differential phase feedback for each SB of one or more SBs associated with the at least one first pilot signal; generating one or more data packets for transmission in accordance with the first CSI report; and transmitting the one or more data packets to the UE.

In a fifteenth aspect, in combination with the fourteenth aspect, the differential phase feedback indicates a phase offset with respect to a previously received indication of an absolute phase feedback.

In a sixteenth aspect, in combination with one or more of the fourteenth aspect to the fifteenth aspect, the first CSI report comprises an indication of whether the first CSI report comprises the differential phase feedback or absolute phase feedback.

In a seventeenth aspect, in combination with the sixteenth aspect, the indication of whether the first CSI report comprises the differential phase feedback or the absolute phase feedback comprises two bits.

In an eighteenth aspect, in combination with one or more of the sixteenth aspect and the seventeenth aspect, the first CSI report comprises: a first part having at least one of a RI, a CQI, or an indication of a number of non-zero wideband amplitude coefficients per layer; and a second part comprising a PMI, wherein the first part further comprise the indication of whether the second part of the first CSI report comprises the differential phase feedback or the absolute phase feedback.

In a nineteenth, in combination with the eighteenth aspect, a presence of a bit in the first part of the first CSI report indicates whether the second part of the first CSI report comprises the differential phase feedback or the absolute phase feedback.

In a twentieth aspect, in combination with one or more of the eighteenth aspect and the nineteenth aspect, the first part further comprises an indication of a step size associated with the differential phase feedback.

In a twenty-first aspect, in combination with one or more of the fourteenth aspect to the twentieth aspect, the first CSI report comprises an indication of a step size associated with the differential phase feedback.

In a twenty-second aspect, in combination with one or more of the fourteenth aspect to the twenty-first aspect, the method also include transmitting at least one second pilot signal; and receiving a second CSI report after transmitting the at least one second pilot signal, the second CSI report comprising an absolute phase feedback for the SB, wherein the differential phase feedback of the first CSI report indicates a phase offset with respect to the absolute phase feedback of the second CSI report, the second CSI report being received prior to the reception of the first CSI report.

In a twenty-third aspect, in combination with the twenty-second aspect, the method may also include transmitting at least one third pilot signal; and receiving a third CSI report after transmitting the at least one third pilot signal, the third CSI report comprising another absolute phase feedback for the SB, the third CSI report being received after the reception of the first CSI report.

In a twenty-fourth aspect, in combination with the twenty-third aspect, the second CSI report is received during a first slot, the third CSI report is received during a second slot, and the method further comprises configuring a period between the first and second slots.

In a twenty-fifth aspect, in combination with one or more of the fourteenth aspect to the twenty-fourth aspect, the differential phase feedback comprises a single bit.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for perform the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communication, comprising:
receiving at least one first pilot signal;
generating a first channel state information (CSI) report based on the at least one first pilot signal, the first CSI report comprising a differential phase feedback for each subband (SB) of one or more SBs associated with the at least one first pilot signal; and
transmitting the first CSI report having the differential phase feedback.

2. The method of claim 1, wherein the differential phase feedback indicates a phase offset with respect to a previously transmitted indication of an absolute phase feedback.

3. The method of claim 1, wherein the first CSI report comprises an indication of whether the first CSI report comprises the differential phase feedback or absolute phase feedback.

4. The method of claim 3, wherein the indication of whether the first CSI report comprises the differential phase feedback or the absolute phase feedback comprises two bits.

5. The method of claim 3, wherein the first CSI report comprises:
a first part having at least one of a rank indicator (RI), a channel quality indicator (CQI), or an indication of a number of non-zero wideband amplitude coefficients per layer; and
a second part comprising a precoding matrix indicator (PMI), wherein the first part further comprise the indication of whether the second part of the first CSI report comprises the differential phase feedback or the absolute phase feedback.

6. The method of claim 5, wherein a presence of a bit in the first part of the first CSI report indicates whether the second part of the first CSI report comprises the differential phase feedback or the absolute phase feedback.

7. The method of claim 5, wherein the first part further comprises an indication of a step size associated with the differential phase feedback.

8. The method of claim 1, wherein the first CSI report comprises an indication of a step size associated with the differential phase feedback.

9. The method of claim 1, further comprising:
detecting an amount of phase offset with respect to a previously transmitted indication of an absolute phase feedback based on the at least one first pilot signal; and
determining whether to provide the differential phase feedback or an absolute phase feedback based on whether the amount of phase offset is greater than a threshold, wherein the first CSI report comprises the differential phase feedback based on the determination.

10. The method of claim 1, further comprising:
receiving at least one second pilot signal;
generating a second CSI report based on the at least one second pilot signal, the second CSI report comprising an absolute phase feedback for the SB, wherein the differential phase feedback of the first CSI report indicates a phase offset with respect to the absolute phase feedback of the second CSI report; and
transmitting the second CSI report, the second CSI report being transmitted prior to the transmission of the first CSI report.

11. The method of claim 10, further comprising:
receiving at least one third pilot signal;
generating a third CSI report based on the at least one third pilot signal, the third CSI report comprising another absolute phase feedback for the SB; and
transmitting the third CSI report, the third CSI report being transmitted after the transmission of the first CSI report.

12. The method of claim 11, wherein:
the second CSI report is transmitted during a first slot;
the third CSI report is transmitted during a second slot; and
a period between the first and second slots is configured by a network entity.

13. The method of claim 1, wherein the differential phase feedback comprises a single bit.

14. A method for wireless communication, comprising:
transmitting at least one first pilot signal;
receiving a first channel state information (CSI) report from a user-equipment (UE) after the transmission of the at least one first pilot signal, the first CSI report comprising a differential phase feedback for each subband (SB) of one or more SBs associated with the at least one first pilot signal;
generating one or more data packets for transmission in accordance with the first CSI report; and
transmitting the one or more data packets to the UE.

15. The method of claim 14, wherein the differential phase feedback indicates a phase offset with respect to a previously received indication of an absolute phase feedback.

16. The method of claim 14, wherein the first CSI report comprises an indication of whether the first CSI report comprises the differential phase feedback or absolute phase feedback.

17. The method of claim 16, wherein the indication of whether the first CSI report comprises the differential phase feedback or the absolute phase feedback comprises two bits.

18. The method of claim 16, wherein the first CSI report comprises:
a first part having at least one of a rank indicator (RI), a channel quality indicator (CQI), or an indication of a number of non-zero wideband amplitude coefficients per layer; and
a second part comprising a precoding matrix indicator (PMI), wherein the first part further comprise the indication of whether the second part of the first CSI report comprises the differential phase feedback or the absolute phase feedback.

19. The method of claim 18, wherein a presence of a bit in the first part of the first CSI report indicates whether the second part of the first CSI report comprises the differential phase feedback or the absolute phase feedback.

20. The method of claim 18, wherein the first part further comprises an indication of a step size associated with the differential phase feedback.

21. The method of claim 14, wherein the first CSI report comprises an indication of a step size associated with the differential phase feedback.

22. The method of claim 14, further comprising:
transmitting at least one second pilot signal; and
receiving a second CSI report after transmitting the at least one second pilot signal, the second CSI report comprising an absolute phase feedback for the SB, wherein the differential phase feedback of the first CSI report indicates a phase offset with respect to the absolute phase feedback of the second CSI report, the second CSI report being received prior to the reception of the first CSI report.

23. The method of claim 22, further comprising:
transmitting at least one third pilot signal; and
receiving a third CSI report after transmitting the at least one third pilot signal, the third CSI report comprising another absolute phase feedback for the SB, the third CSI report being received after the reception of the first CSI report.

24. The method of claim 23, wherein:
the second CSI report is received during a first slot;
the third CSI report is received during a second slot; and
the method further comprises configuring a period between the first and second slots.

25. The method of claim 14, wherein the differential phase feedback comprises a single bit.

26. An apparatus for wireless communication, comprising:
a receiver configured to receive at least one first pilot signal;
a processing system configured to generate a first channel state information (CSI) report based on the at least one first pilot signal, the first CSI report comprising a differential phase feedback for each subband (SB) of one or more SBs associated with the at least one first pilot signal; and
a transmitter configured to transmit the first CSI report having the differential phase feedback.

27. An apparatus for wireless communication, comprising:
a transmitter configured to transmit at least one first pilot signal;
a receiver configured to receive a first channel state information (CSI) report from a user-equipment (UE) after the transmission of the at least one first pilot signal, the first CSI report comprising a differential phase feedback for each subband (SB) of one or more SBs associated with the at least one first pilot signal; and
a processing system configured to generate one or more data packets for transmission in accordance with the first CSI report, wherein the transmitter is further configured to transmit the one or more data packets to the UE.

28. An apparatus for wireless communication, comprising:
means for receiving at least one first pilot signal;
means for generating a first channel state information (CSI) report based on the at least one first pilot signal, the first CSI report comprising a differential phase feedback for each subband (SB) of one or more SBs associated with the at least one first pilot signal; and
means for transmitting the first CSI report having the differential phase feedback.

29. An apparatus for wireless communication, comprising:
means for transmitting at least one first pilot signal;
means for receiving a first channel state information (CSI) report from a user-equipment (UE) after the transmission of the at least one first pilot signal, the first CSI report comprising a differential phase feedback for each subband (SB) of one or more SBs associated with the at least one first pilot signal;
means for generating one or more data packets for transmission in accordance with the first CSI report; and
means for transmitting the one or more data packets to the UE.

30. A computer-readable medium having instructions stored thereon to cause a processor to:
receive at least one first pilot signal;
generate a first channel state information (CSI) report based on the at least one first pilot signal, the first CSI report comprising a differential phase feedback for each subband (SB) of one or more SBs associated with the at least one first pilot signal; and
transmit the first CSI report having the differential phase feedback.

31. A computer-readable medium having instructions stored thereon to cause a processor to:
transmit at least one first pilot signal;
receive a first channel state information (CSI) report from a user-equipment (UE) after the transmission of the at least one first pilot signal, the first CSI report comprising a differential phase feedback for each subband (SB) of one or more SBs associated with the at least one first pilot signal;
generate one or more data packets for transmission in accordance with the first CSI report; and
transmit the one or more data packets to the UE.
